(19) United States
(12) Patent Application Publication
(10) Pub. No.: US 2024/0316498 A1
(43) Pub. Date: Sep. 26, 2024

(54) SYSTEMS AND METHODS PROVIDING FOR REDUCING ENERGY AND EQUIPMENT REQUIRED IN PROGRESSIVE NANOFILTRATION CONCENTRATION

(71) Applicant: Fluid Technology Solutions (FTS), Inc., Albany, OR (US)

(72) Inventors: John R. Herron, Corvallis, OR (US); Edward Gerard Beaudry, Albany, OR (US); Keith A. Lampi, Albany, OR (US)

(21) Appl. No.: 18/546,574

(22) PCT Filed: Feb. 18, 2022
(86) PCT No.: PCT/US2022/016927

§ 371 Date: Aug. 15, 2023

Related U.S. Application Data
(60) Provisional application No. 63/150,772, filed on Feb. 18, 2021.

(51) Int. Cl. B01D 61/02; B01D 61/58

(52) U.S. Cl. CPC B01D 61/029; B01D 61/58; B01D 61/025; B01D 61/0271; B01D 2311/04; B01D 2311/06; B01D 2311/25

(57) ABSTRACT

Examples relate to systems and methods for reducing the energy required to concentrate solutions by nanofiltration to concentrations with osmotic pressures far above the applied pressure. In an embodiment, a method may include separating permeate streams from successive stages of a nanofiltration process, the separated permeate streams having a higher salinity from the elements at the end of the nanofiltration process. The method also may include reinjecting the permeate stream into a nanofiltration brine stream at one or more locations where the nanofiltration brine stream and the permeate stream have substantially similar concentrations.

### CROSS-REFERENCE TO RELATED APPLICATIONS

This application claims priority to U.S. Provisional Patent Application No. 63/150,772 filed on Feb. 18, 2021, the disclosure of which is incorporated herein, in its entirety, by this reference.

### BACKGROUND

Concentration of high strength salt brines is often required for industries such as chlor-alkali or in situations where zero-liquid-discharge is mandated. Typically, such dewatering is performed by evaporation, which is energy- and capital-intensive. US Patent Application Publication No. 2015/0014248 (“'248 application”) describes a membrane process for achieving high salt brines, the disclosure of which is hereby incorporated, in its entirety, by reference.

The membrane process described in the '248 application is similar to reverse osmosis (RO) in that it uses high pressure to force water through a semipermeable membrane. RO is limited in the amount of water it can remove since commercial membrane systems are limited to pressures of at most 120 bar due to materials issues. This pressure can only produce a 110,000 ppm NaCl solution due to the osmotic pressure of the solution. The membrane and process in the '248 application uses a more permeable nanofiltration membrane that allows salt to slowly permeate through the membrane, which creates a saline permeate. The osmotic potential of salt on the permeate side allows more water to be forced from the feed solution until the difference in osmotic pressures between the feed and the permeate is equal to the applied pressure.

It was proposed that a salt solution be dewatered as much as possible with RO then the RO retentate be fed to a series of nanofiltration elements at high pressure to produce a final retentate with osmotic pressures far above the applied pressure. The saline permeate is substantially less salty than the retentate, so it was proposed in the '248 application that the permeate be returned to the feed of the RO.

### SUMMARY

Systems and methods for reducing the energy required to concentrate solutions by nanofiltration to concentrations with osmotic pressures far above the applied pressure are described herein. In an embodiment, a method includes separating permeate streams from successive stages of a nanofiltration process, the separated permeate streams having a higher salinity from the elements at the end of the nanofiltration process. The method also includes reinjecting the permeate stream into a nanofiltration brine stream at one or more locations where the nanofiltration brine stream and the permeate stream have substantially similar concentrations.

In an embodiment, a method of concentrating nanofiltration permeate is described. The method includes feeding an initial solution having an initial concentration of a solute into a reverse osmosis (RO) system to form a first retentate having a first concentration of the solute that is greater than the initial concentration of the solute. The method includes feeding the first retentate having the first concentration of the solute into a first high-pressure nanofiltration system having one or more element trains in parallel to form a second permeate stream and a second retentate. Each of the one or more element trains of the first high-pressure nanofiltration system have multiple elements in series. The second permeate stream has a concentration of the solute approximately equal to the initial concentration of the solute or within a predetermined range of the initial concentration of the solute. The second retentate has a second concentration of the solute greater than the first concentration of the solute. The method includes feeding at least the second retentate having the second concentration of the solute into a second high-pressure nanofiltration system having one or more element trains in parallel to form a third permeate stream and a third retentate, each of the one or more element trains of the second high-pressure nanofiltration system having multiple elements in series. The third permeate stream has a concentration of the solute approximately equal to or within a predetermined range of the first concentration of the solute in the first retentate output by the RO system. The third retentate has a third concentration of the solute greater than the second concentration of the solute in the second retentate. The method also includes at least one of (1) mixing the second permeate stream from the first high-pressure nanofiltration system with additional initial solution having approximately the initial concentration of the solute before the additional initial solution is fed into the RO system, or (2) mixing the third permeate stream from the second high-pressure nanofiltration system with additional first retentate having approximately the first concentration of the solute before the additional first retentate is fed into the first high-pressure nanofiltration system.

In an embodiment, a system for concentrating nanofiltration permeate is described. The system includes a feed tank configured to receive at least an initial solution having an initial concentration of a solute. The system includes a reverse osmosis (RO) system configured to receive the initial solution pumped from the feed tank and dewater the initial solution to form a first retentate having a first concentration of the solute that is greater than the initial concentration of the solute. The system includes a first high-pressure nanofiltration system having one or more element trains in parallel having multiple elements in series. The first high-pressure nanofiltration system is configured to receive the first retentate pumped from the first RO system and form a second permeate stream and a second retentate. The second permeate stream has a concentration of the solute approximately equal or within a predetermined range of the initial concentration of the solute fed into the RO system. The second retentate has a second concentration of the solute greater than the first concentration of the solute output by the RO system. The system includes a second high-pressure nanofiltration system having one or more element trains in parallel having is multiple elements in series. The second high-pressure nanofiltration system configured to receive the second retentate pumped from the first high-pressure nanofiltration system and form a third permeate stream and a third retentate. The third permeate stream has a concentration of the solute approximately equal to or within a predetermined range of the first concentration of the solute output by the RO system. The third retentate has a third concentration of the solute greater than the second concentration of the solute output by the first high-pressure nanofiltration system. The system also includes at least one of (1) a line directing the second permeate stream from the first high-pressure nanofiltration system to the feed tank to mix the second permeate stream with an additional initial solution having approximately the initial concentration of the solute before the additional initial solution is fed into the RO system, or (2) a line directing the third permeate stream from the second high-pressure nanofiltration system to mix with additional first retentate having approximately the first concentration of the solute before the additional first retentate is fed into the first high-pressure nanofiltration system.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic of a high pressure nanofiltration system described in the '248 application.

FIG. 2 is a schematic of an improved system and process for re-introducing nanofiltration permeate in a manner that saves both energy and capital equipment, according to an embodiment.

### DETAILED DESCRIPTION

Embodiments disclosed herein are related to systems and methods resulting in the technical effect of reduction of required energy and equipment in progressive nanofiltration concentration. The present disclosure provides one or more embodiments of methods and systems for reducing the power and equipment required to concentrate solutions from conventional concentration methods and systems. At least one, some, or all embodiment of systems and methods described herein prevent an inefficiency in conventional concentration systems and methods, such as the systems and methods described in the '248 application. For example, in the '248 application, at least some (e.g., all) of the permeate streams are mixed and reintroduced together to the feed to the reverse osmosis (“RO”) system. The permeate streams from different stages of the nanofiltration concentration vary dramatically in concentration, so mixing the permeate streams together produces an increase in entropy of the solutions. Separating the mixed permeate solution into water and 250 parts per thousand (“ppt”) brine, then, requires more energy than if the permeate solutions were processed separately.

The systems and methods described herein may avoid mixing permeates of different salinities by collecting the permeate from different stages of the nanofiltration system. The permeate collected from the different stages of the nanofiltration system may then be reinjected back into the nanofiltration feed stream at particular locations in previous stages of the system where the feed concentration is near or corresponds the concentration of the later stage collected permeate. This process avoids the mixing of brines of different concentrations and the resulting entropy increase.

To illustrate the execution of the systems and methods, two high pressure nanofiltration systems were modeled. One system returned the permeate to the RO feed as proposed in the '248 application and the other system separated permeate streams and reinjected the separated permeate streams into the nanofiltration system at appropriate place (e.g., stages) having concentrations near or corresponding to the separated permeate streams. Both systems were modeled at about 70 bar operation and both were fed about 24.2 m³/hr NaCl at about 35 parts per thousand (ppt) to produce about 21 m³/hr water and about 3.2 m³/hr brine at about 250 ppt.

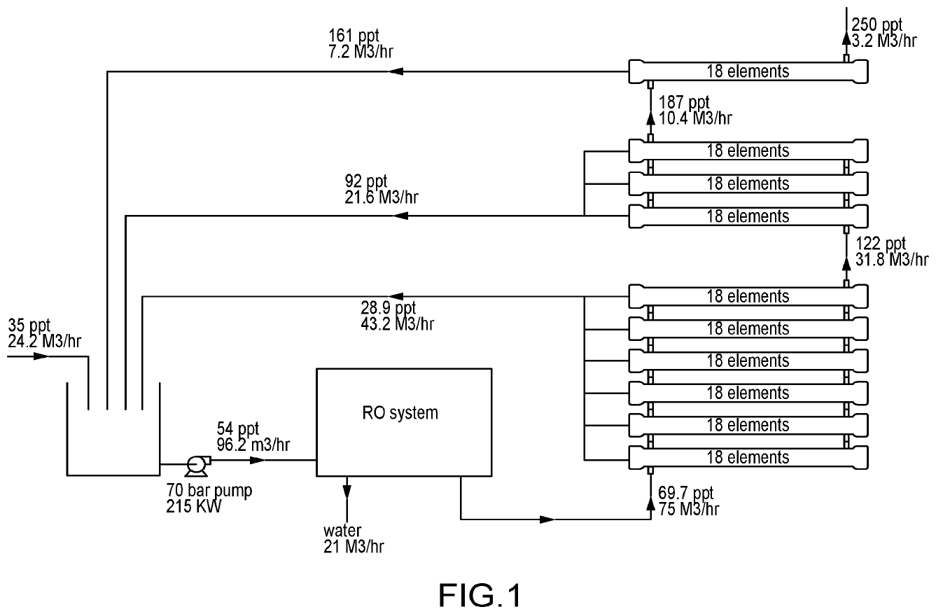

A schematic of the example of a high pressure nanofiltration system of the type described in the '248 application is shown in FIG. 1. The example shown in FIG. 1 has all permeate streams from the high pressure nanofiltration returned to the feed to the RO as was described in the '248 application. The performance of the elements was modeled assuming membranes were available with a range of permeabilities (B values), and the B values of the membranes were selected so that the permeation rate was about 10 liters per square meter per hour (LMH) throughout the system. This requires the B values of the elements to increase as the concentration increases.

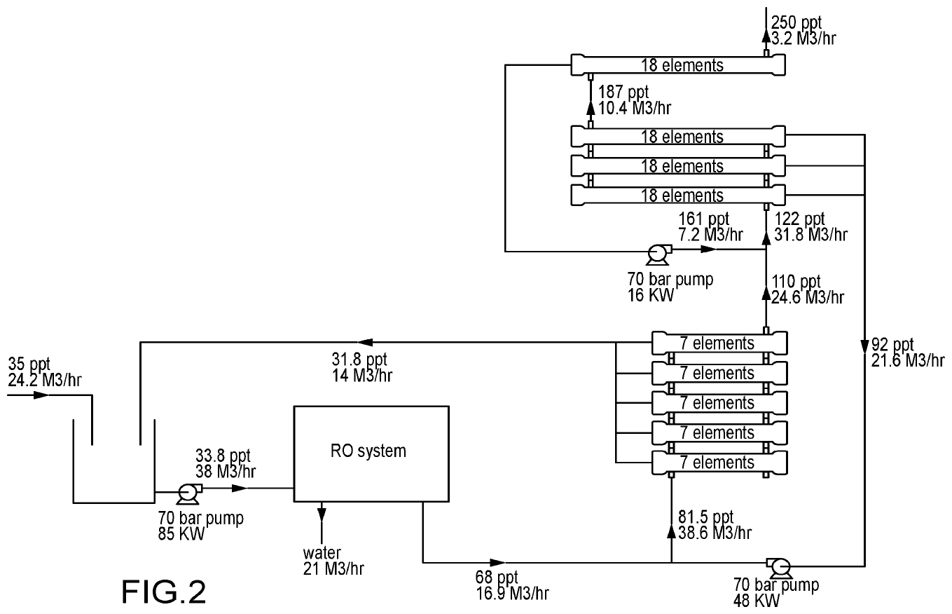

FIG. 2 shows an improved system and process for re-introducing the nanofiltration permeate in a manner that results in the technical effect of saving both energy and capital equipment. A permeation rate of about 10 LMH was also used in modeling the system in FIG. 2.

The system in FIG. 1 starts with the about 35 ppt NaCl being blended in a tank with the permeate from the high-pressure nanofiltration system. A 70 bar pump transfers the about 54.5 ppt solution from the feed tank to an RO system at a rate of about 96.1 m³/hr. Assuming about 85% efficiency, the pump requires about 215 KW. The RO system dewaters the feed, producing a water stream of about 21 m³/hr and a brine stream of about 75 m³/hr at about 69.7 ppt.

The about 69.7 ppt brine is concentrated initially by nanofiltration using a bank of six nanofiltration trains in parallel, each train having 18 elements in series. At the outlet of the first bank, the brine flow is about 31.8 m³/hr at about 122 ppt. The collected permeate is about 43.2 m³/hr at about 28.9 ppt. The second bank of elements has three, 18 element, trains in parallel. The brine flow is reduced to about 10.4 m³/hr with the concentration increasing to about 187 ppt. The permeate from the second bank is about 21.6 m³/hr at about 92 ppt. The last stage of nanofiltration is a single, 18 element train where the final concentration of 250 ppt is achieved at a flow of about 3.2 m³/hr. The permeate from the last stage is about 7.2 m³/hr at about 161 ppt. The total number of nanofiltration elements in the system of FIG. 1 is about 180 and about 215 KW of pumping is required.

The system in FIG. 2 also concentrates about 24.2 m³/hr of about 35 ppt sodium chloride to about 3.2 m³/hr at about 250 ppt, and about 21 m³/hr of RO quality water is produced.

The flow scheme starts with the about 35 ppt NaCl being blended in a tank with the permeate from just the first bank of the high-pressure nanofiltration system. An about 70 bar pump transfers the about 33.8 ppt solution from the feed tank to an RO system at a rate of about 38.1 m³/hr. Assuming about 85% efficiency, the pump requires about 85 KW. The RO system dewaters the feed, producing a water stream of about 21 m³/hr and a brine stream of about 16.9 m³/hr at about 68 ppt.

Instead of being fed directly to the first bank of nanofiltration elements, the brine is mixed with the permeate from the second bank of nanofiltration elements. The permeate stream of the second bank 2 is about 21.6 m³/hr at about 92 ppt and may be pressurized to about 70 bar, requiring a 48 KW pump. The combined brine feed to the first bank of nanofiltration elements is about 38.6 m³/hr at about 81.5 ppt.

The first bank of nanofiltration elements in FIG. 2 only requires a bank of five element trains in parallel, each train being 7 elements in series. At the outlet of the first bank the brine flow is about 24.6 m³/hr at about 110 ppt. The collected permeate is about 14 m³/hr at about 31.8 ppt.

Before entering the second bank of elements the brine is mixed with the permeate from the final bank of elements. The final bank permeate is about 7.2 m³/hr at about 161 ppt and it must be pressurized to about 70 bar with a 16 KW pump. The feed to the second bank of elements is about 31.8 m³/hr at about 122 ppt.

The second bank of elements has three trains in parallel of 18 elements each. The brine flow from the second bank is about 10.4 m³/hr at about 187 ppt.

As in FIG. 1, the last stage of nanofiltration is a single, 18 element train where the final concentration of about 250 ppt is achieved at a flow of about 3.2 m³/hr.

In the improved system and process shown in FIG. 2, the identical amount of concentrate is produced as the system in FIG. 1, however only about 149 KW and 107 elements are required.

The systems and methods described herein are not limited to NaCl streams but also may be applied to numerous solutions, including ammonium sulfate, glycerin, and dextrose. The systems and methods described herein may be applied to a solution which has a solubility above the osmotic potential achievable by reverse osmosis.

The applied pressure to the nanofiltration elements can range from standard nanofiltration pressures of less than about 10 bar to pressures as high as membrane element design allows. In an example, 70 bar was used because 70 bar is a standard pressure for spiral wound elements in seawater desalination. In general, higher element pressures deliver higher energy efficiencies and lower element counts, however nanofiltration elements operating at pressures above 75 bar are unproven in terms of long-term performance.

The savings in equipment and energy achievable are not limited by those shown in the example. Further separation of streams and injection at locations where the process brine and the reinjected brine are of identical salinities may increase energy and element savings, but may require more pumps and controls. Development of nanofiltration membranes suitable for higher pressures would also increase savings.

In some embodiments, a method and system of concentrating nanofiltration permeate includes feeding a solution having a concentration of a solute into a feed tank. For example a solution having a concentration of about 35 ppt of solute may be feed into a feed tank at a rate of about 24 m³/hr. In some embodiments, the solution may be include other concentrations of the solute, such as about 20 ppt to about 50 ppt, about 25 ppt to about 45 ppt, about 25 ppt to about 30 ppt, about 30 ppt to about 35 ppt, about 35 ppt to about 40 ppt, or about 40 ppt to about 45 ppt. In some embodiments, the solution may be fed into the feed tank at other rates.

The method also may include feeding an initial solution from the feed tank and having an initial concentration of a solute into a RO system to form a first retentate having a first concentration of the solute that is greater than the initial concentration of the solute. For example, the initial solution fed into the RO system may include an initial concentration of the solute of about 33.8 ppt and about 38 m³/hr. In some embodiments, the solution may be include other concentrations of the solute, such as about 20 ppt to about 50 ppt, about 25 ppt to about 45 ppt, about 25 ppt to about 30 ppt, about 30 ppt to about 35 ppt, about 35 ppt to about 40 ppt, or about 40 ppt to about 45 ppt. The initial concentration of the solute in the solution fed into the RO system from the feed tank may slightly different from the concentration of the solute fed into the feed tank due to mixing of the solution in the feed tank with a permeate stream from a high-pressure nanofiltration system (described in the method below). In some embodiments, the initial solution may be fed into the RO system at other rates. An initial pump may be used to pump the initial solution to the RO system. For example, a 70 bar pump requiring about 85 KW of energy may pump the initial solution into the RO system.

The first concentration of the solute in the first retentate formed by the RO system is greater than the initial concentration of the solute in the initial solution fed into the RO system. For example, the first concentration of the solute in the first retentate may be about 68 ppt. In some embodiments, the first concentration of the solute in the first retentate may be about 55 ppt to about 95 ppt, about 55 ppt to about 65 ppt, about 65 ppt to about 75 ppt, about 75 ppt to about 85 ppt, about 85 ppt to about 95, about 60 ppt to about 65 ppt, about 65 ppt to about 70 ppt, or about 70 to about 75 ppt. Water also may be pulled or pumped from the RO system.

In some embodiments, the method and system includes feeding at least the first retentate having the first concentration of the solute into a first high-pressure nanofiltration system to form a second permeate stream and a second retentate. The first high-pressure nanofiltration system may include one or more element trains in parallel, each of the one or more element trains of the first high-pressure nanofiltration system having multiple elements in series. In some embodiments, the first high-pressure nanofiltration system has multiple element trains in parallel each having multiple elements in series. More particularly, the first high-pressure nanofiltration system may include five element trains in parallel, each of the five element trains having ten or less elements in series. For example, the first high-pressure nanofiltration system may include five element trains each having seven elements in series.

The second permeate stream formed from the first high-pressure nanofiltration system may have a concentration of the solute approximately equal to or within a predetermined range (either less than or greater than) of the initial concentration of the solute in the initial solution fed into the RO system or the concentration of the solute in the solution fed into the feed tank. For example, the concentration of the solute in the second permeate stream may be within a predetermined range of about ±5%, about ±10%, about ±15%, about ±20%, about ±25%, about ±30%, about ±40%, or about ±50% of the initial concentration of the solute in the initial solution fed into the RO system or the concentration of the solute in the solution fed into the feed tank. In the example shown in FIG. 2, the concentration of the solute in the second permeate stream is about 31.8 ppt and the concentration of the solute in the solution fed into the feed tank is about 35.

The second permeate stream may be mixed with the solution fed into the feed tank, resulting in the initial solution having an initial concentration of the solution that is between the concentration of the solute in the second permeate stream and the solution fed into the feed tank. In the example shown in FIG. 2, the concentration of the solute in the initial solution is 33.8 ppt, between the concentration of the solute of 31.8 ppt in the second permeate stream and the concentration of the solute of 35 ppt of the solution fed into the feed tank. A line extending between the first high-pressure nanofiltration system and the feed tank may direct or feed the second permeate stream to the feed tank. Feeding the second permeate stream having the concentration of the solute into the feed tank to mix the second retentate with a solution having a concentration of the solute near or within a predetermined range of the concentration of the solute in the second permeate stream avoids the solutions having drastically different concentrations of the solute and the resulting entropy increase.

The first high-pressure nanofiltration system also may form a second retentate having a second concentration of the solute greater than the first concentration of the solute. For example, the second retentate may include a second concentration of the solute of about 110 ppt, about 90 ppt to about 130 ppt, about 100 ppt to about 120 ppt, about 95 ppt to about 105 ppt, about 105 ppt to about 115 ppt, or about 115 ppt to about 125 ppt. The second retentate may be output from the first high-pressure nanofiltration system at various rates, such as a rate of about 24.6 m³/hr.

The method and system also may include feeding the second retentate having the second concentration of the solute into a second high-pressure nanofiltration system to form a third permeate stream and a third retentate. The second high-pressure nanofiltration system may include one or more element trains in parallel having multiple elements in series. For example, the second high-pressure nanofiltration system may include multiple element trains in parallel each having multiple elements in series. In some embodiments, the second high-pressure nanofiltration system has three element trains in parallel having ten or more elements in series. Specifically, the second high-pressure nanofiltration system may include three element trains in parallel having eighteen elements in series. In some embodiments, the second high-pressure nanofiltration system has fewer element trains in parallel than the first high-pressure nanofiltration system, and each element train in parallel in the second high-pressure nanofiltration system has more elements in series than each element train in parallel in the first high-pressure nanofiltration system.

The second high-pressure nanofiltration system may form the third permeate stream having a concentration of the solute approximately equal to or within a predetermined range (either less than or greater than) of the first concentration of the solute in the first retentate output by the RO system. For example, the concentration of the solute in the third permeate stream may be within a predetermined range of about +5%, about ±10%, about +15%, about ±20%, about ±25%, about ±30%, about ±40%, or about ±50% of the first concentration of the solute in the first retentate output by the RO system. In the example shown in FIG. 2, the concentration of the solute in the third permeate stream is about 92 ppt and the first concentration of the solute in the first retentate output by the RO system is about 68.

The third permeate stream may be mixed with the initial solution (e.g., additional solution) output by the RO system, and the resulting mixture of the initial solution output by the RO system and the third permeate stream may be fed into the first high-pressure nanofiltration system. The resulting mixture of the initial solution and the third permeate stream may have a concentration that is between the initial concentration of the solute in the in the initial solution and the concentration of the solute in the third permeate stream output by the second high-pressure nanofiltration system. In the example shown in FIG. 2, the initial concentration of the solute in the initial solution may be about 68 ppt, the concentration of the solute in the third permeate stream may be about 92 ppt, and the concentration of the solute in the mixture of the initial solution and the third permeate stream that is fed into the first high-pressure nanofiltration system may be about 81.5 ppt. A line extending at least partially between the second high-pressure nanofiltration system and the first high-pressure nanofiltration system may direct or feed the third permeate stream to mix with the initial solution before being fed to the first high-pressure nanofiltration system. Feeding the third permeate stream to mix the third permeate stream with the initial solution having the initial concentration of the solute near or within a predetermined range of the concentration of the solute in the third permeate stream avoids the solutions having drastically different concentrations of the solute and the resulting entropy increase. A pump may pump the third permeate stream to mix with the initial solution. For example, a 70 bar pump may require 48 KW of energy to pump the third permeate stream to mix with the initial solution before the resulting mixture is fed into the first high-pressure nanofiltration system.

The second high-pressure nanofiltration system also may form a third retentate having a third concentration of the solute greater than the second concentration of the solute in the second retentate output by the first high-pressure nanofiltration system. For example, the third retentate may include a third concentration of the solute of about 187 ppt, about 160 ppt to about 210 ppt, about 180 ppt to about 195 ppt, about 160 ppt to about 170 ppt, about 170 ppt to about 180 ppt, about 180 ppt to about 190 ppt, about 190 ppt to about 200 ppt, or about 210 ppt. The third retentate may be output from the second high-pressure nanofiltration system at various rates, such as a rate of about 10.4 m³/hr.

In some embodiments, the method and system may include feeding the third retentate having the third concentration of the solute into a third high-pressure nanofiltration system to form a fourth permeate stream and a fourth retentate. The third high-pressure nanofiltration system may include one or more element trains in parallel having multiple elements in series. For example, the third high-pressure nanofiltration system may include only one element train having ten or more elements in series. Specifically, the third high-pressure nanofiltration system may include only one is element train having eighteen elements in series. In some embodiments, the third high-pressure nanofiltration system has fewer element trains in parallel than the first high-pressure nanofiltration system and the second high-pressure nanofiltration system.

The third high-pressure nanofiltration system may form the fourth permeate stream having a concentration of the solute approximately equal to or within a predetermined range (either less than or greater than) of the second concentration of the solute in the second retentate output by the first high-pressure nanofiltration system. For example, the concentration of the solute in the fourth permeate stream may be within a predetermined range of about ±5%, about ±10%, about ±15%, about ±20%, about ±25%, about ±30%, about ±40%, or about ±50% of the second concentration of the solute in the second retentate output by the first high-pressure nanofiltration system. In the example shown in FIG. 2, the concentration of the solute in the fourth permeate stream is about 161 ppt and the second concentration of the solute in the second retentate output by the first high-pressure nanofiltration system is about 110.

The fourth permeate stream may be mixed with the second retentate (e.g., additional second retentate) output by the first high-pressure nanofiltration system, and the resulting mixture of the second retentate output by the first high-pressure nanofiltration system and the fourth permeate stream may be fed into the second high-pressure nanofiltration system. The resulting mixture of the second retentate and the fourth permeate stream may have a concentration that is between the second concentration of the solute in the in the second retentate and the concentration of the solute in the fourth permeate stream output by the third high-pressure nanofiltration system. In the example shown in FIG. 2, the second concentration of the solute in the second retentate may be about 110 ppt, the concentration of the solute in the fourth permeate stream may be about 161 ppt, and the concentration of the solute in the mixture of the second retentate and the fourth permeate stream that is fed into the second high-pressure nanofiltration system may be about 122 ppt. A line extending at least partially between the third high-pressure nanofiltration system and the second high-pressure nanofiltration system may direct or feed the fourth permeate stream to mix with the second retentate before being fed to the second high-pressure nanofiltration system. Feeding the fourth permeate stream to mix the fourth permeate stream with the second retentate having the second concentration of the solute near or within a predetermined range of the concentration of the solute in the fourth permeate stream avoids the solutions having drastically different concentrations of the solute and the resulting entropy increase. A pump may pump the is fourth permeate stream to mix with the second retentate. For example, a 70 bar pump may require 16 KW of energy to pump the fourth permeate stream to mix with the second before the resulting mixture is fed into the second high-pressure nanofiltration system.

The third high-pressure nanofiltration system also may form a fourth retentate having a fourth concentration of the solute greater than the third concentration of the solute in the third retentate output by the second high-pressure nanofiltration system. For example, the fourth retentate may include a fourth concentration of the solute of about 250 ppt, about 225 ppt to about 275 ppt, about 240 ppt to about 260 ppt, about 225 ppt to about 235 ppt, about 235 ppt to about 245 ppt, about 245 ppt to about 255 ppt, about 255 ppt to about 265 ppt, or about 265 ppt to about 275 ppt. The fourth retentate may be output from the third high-pressure nanofiltration system at various rates, such as a rate of about 3.2 m³/hr.

The solute in the solutions, retentate, and permeate streams of the systems and methods may include a number of different solutes. For example, in some embodiments, the solute is sodium chloride. In some embodiments, the solute is at least one of ammonium sulfate, glycerin, or dextrose.

Features from any of the disclosed embodiments may be used in combination with one another, without limitation. In addition, other features and advantages of the present disclosure will become apparent to those of ordinary skill in the art through consideration of the following detailed description and the accompanying drawings.

As used herein, the term “about” or “substantially” refers to an allowable variance of the term modified by “about” or “substantially” by ±10% or ±5%. Further, the terms “less than,” “or less,” “greater than,” “more than,” or “or more” include, as an endpoint, the value that is modified by the terms “less than,” “or less,” “greater than,” “more than,” or “or more.”

While various aspects and embodiments have been disclosed herein, other aspects and embodiments are contemplated. The various aspects and embodiments disclosed herein are for purposes of illustration and are not intended to be limiting.

1. (canceled)

2. A method of concentrating nanofiltration permeate, the method comprising:
feeding an initial solution having an initial concentration of a solute into a reverse osmosis (RO) system to form a first retentate having a first concentration of the solute that is greater than the initial concentration of the solute;
feeding the first retentate having the first concentration of the solute into a first high-pressure nanofiltration system having one or more element trains in parallel to form a second permeate stream and a second retentate, each of the one or more element trains of the first high-pressure nanofiltration system having multiple elements in series, the second permeate stream having a concentration of the solute approximately equal to the initial concentration of the solute or within a predetermined range of the initial concentration of the solute, and the second retentate having a second concentration of the solute greater than the first concentration of the solute;
feeding at least the second retentate having the second concentration of the solute into a second high-pressure nanofiltration system having one or more element trains in parallel to form a third permeate stream and a third retentate, each of the one or more element trains of the second high-pressure nanofiltration system having multiple elements in series, the third permeate stream having a concentration of the solute approximately equal to or within a predetermined range of the first concentration of the solute in the first retentate output by the RO system, and the third retentate having a third concentration of the solute greater than the second concentration of the solute in the second retentate; and
at least one of:
mixing the second permeate stream from the first high-pressure nanofiltration system with additional initial solution having approximately the initial concentration of the solute before the additional initial solution is fed into the RO system; or
mixing the third permeate stream from the second high-pressure nanofiltration system with additional first retentate having approximately the first concentration of the solute before the additional first retentate is fed into the first high-pressure nanofiltration system.

3. The method of claim 2, wherein the first high-pressure nanofiltration system has multiple element trains in parallel each having multiple elements in series.

4. (canceled)

5. The method of claim 2, wherein the second high-pressure nanofiltration system has multiple element trains in parallel each having multiple elements in series.

6. (canceled)

7. The method of claim 2, wherein the second high-pressure nanofiltration system has fewer element trains in parallel than the first high-pressure nanofiltration system, and wherein each element train in parallel in the second high-pressure nanofiltration system has more elements in series than each element train in parallel in the first high-pressure nanofiltration system.

8. The method of claim 2, wherein the method includes both:
mixing the second permeate stream from the first high-pressure nanofiltration system with additional initial solution having approximately the initial concentration of the solute before the additional initial solution is fed into the RO system; and
mixing the third permeate stream from the second high-pressure nanofiltration system with additional first retentate having approximately the first concentration of the solute before the additional first retentate is fed into the first high-pressure nanofiltration system.

9. The method of claim 2, further comprising feeding the third retentate having the third concentration of the solute into a third high-pressure nanofiltration system having one or more element trains in parallel to form a fourth permeate stream and a fourth retentate, each of the one or more element trains of the third high-pressure nanofiltration system having multiple elements in series, the fourth permeate stream having a concentration of the solute approximately equal to or within a predetermined range of the second concentration of the solute in the second retentate output by the first high-pressure nanofiltration system, and the fourth retentate having a fourth concentration of the solute greater than the third concentration of the solute in the third retentate.

10. The method of claim 9, further comprising mixing the fourth permeate stream from the third high-pressure nanofiltration system with additional second retentate from the first high-pressure nanofiltration system having approximately the third concentration of the solute before the additional second retentate is fed into the second high-pressure nanofiltration system.

11. The method of claim 9, wherein the third high-pressure nanofiltration system has only one element train having ten or more elements in series.

12. The method of claim 9, wherein the third high-pressure nanofiltration system has fewer element trains in parallel than the first high-pressure nanofiltration system and the second high-pressure nanofiltration system.

13. The method of claim 2, wherein the solute is sodium chloride and the solute is at least one of ammonium sulfate, glycerin, or dextrose.

14. (canceled)

15. A system for concentrating nanofiltration permeate, the system comprising:
a feed tank configured to receive at least an initial solution having an initial concentration of a solute;
a reverse osmosis (RO) system configured to receive the initial solution pumped from the feed tank and dewater the initial solution to form a first retentate having a first concentration of the solute that is greater than the initial concentration of the solute;
a first high-pressure nanofiltration system having one or more element trains in parallel having multiple elements in series, the first high-pressure nanofiltration system configured to receive the first retentate pumped from the first RO system and form:
a second permeate stream having a concentration of the solute approximately equal or within a predetermined range of the initial concentration of the solute fed into the RO system; and
a second retentate having a second concentration of the solute greater than the first concentration of the solute output by the RO system;
a second high-pressure nanofiltration system having one or more element trains in parallel having multiple elements in series, the second high-pressure nanofiltration system configured to receive the second retentate pumped from the first high-pressure nanofiltration system and form:
a third permeate stream having a concentration of the solute approximately equal to or within a predetermined range of the first concentration of the solute output by the RO system; and
a third retentate having a third concentration of the solute greater than the second concentration of the solute output by the first high-pressure nanofiltration system; and
at least one of:
a line directing the second permeate stream from the first high-pressure nanofiltration system to the feed tank to mix the second permeate stream with an additional initial solution having approximately the initial concentration of the solute before the additional initial solution is fed into the RO system; or
a line directing the third permeate stream from the second high-pressure nanofiltration system to mix with additional first retentate having approximately the first concentration of the solute before the additional first retentate is fed into the first high-pressure nanofiltration system.

16. The system of claim 15, wherein the first high-pressure nanofiltration system has multiple element trains in parallel each having multiple elements in series.

17. (canceled)

18. The system of claim 15, wherein the second high-pressure nanofiltration system has multiple element trains in parallel each having multiple elements in series.

19. (canceled)

20. The system of claim 15, wherein the second high-pressure nanofiltration system has fewer element trains in parallel than the first high-pressure nanofiltration system, and wherein each element train in parallel in the second high-pressure nanofiltration system has more elements in series than each element train in parallel in the first high-pressure nanofiltration system.

21. The system of claim 15, wherein the system includes both:
the line directing the second permeate stream from the first high-pressure nanofiltration system to the feed tank to mix the second permeate stream with the additional initial solution having approximately the initial concentration of the solute before the additional initial solution is fed into the RO system; and
the line directing the third permeate stream from the second high-pressure nanofiltration system to mix with the additional first retentate having approximately the first concentration of the solute before the additional first retentate is fed into the first high-pressure nanofiltration system.

22. The system of claim 15, further comprising a third high-pressure nanofiltration having one or more element trains in parallel having multiple elements in series, the third high-pressure system configured to receive the third retentate having the third concentration of the solute from the second high-pressure nanofiltration system and form:
a fourth permeate stream having a concentration of the solute approximately equal to the second concentration of the solute or within a predetermined range of the second concentration of the solute; and
a fourth retentate having a fourth concentration of the solute greater than the third concentration of the solute.

23. The system of claim 22, further comprising a line directing the fourth permeate stream from the third high-pressure nanofiltration system to mix with additional second retentate from the first high-pressure nanofiltration system having approximately the second concentration of the solute before the additional second retentate is fed into the second high-pressure nanofiltration system.

24. The system of claim 22, wherein the third high-pressure nanofiltration system has only one element train having ten or more elements in series.

25. The system of claim 22, wherein the third high-pressure nanofiltration system has fewer element trains in parallel than the first high-pressure nanofiltration system and the second high-pressure nanofiltration system.

26. The system of claim 22, further comprising:
an initial pump configured to pump the initial solution to the RO system;
a first pump configured to pump the third permeate stream to mix with the first retentate from the RO system before entering the first high-pressure nanofiltration system; and
a second pump configured to pump the fourth permeate stream to mix with the second retentate from the first high-pressure nanofiltration system before entering the second high-pressure nanofiltration system.

27. The system of claim 15, wherein the solute is sodium chloride and the solute is at least one of ammonium sulfate, glycerin, or dextrose.

28. (canceled)
